(19) United States
(12) Patent Application Publication
(10) Pub. No.: US 2025/0116813 A1
(43) Pub. Date: Apr. 10, 2025

(54) METHOD AND DEVICE FOR CONVERTING MULTI SINGLE BEAM OF MULTI SINGLE MODE FROM SINGLE BEAM OF SINGLE MODE, MULTI SINGLE BEAM MADE BY METHOD, METHOD OF MEASURING MULTI SINGLE BEAM, AND RECHARGEABLE BATTERY WELDED WITH MULTI SINGLE BEAM

(71) Applicant: SAMSUNG SDI CO., LTD., Yongin-si (KR)

(72) Inventors: Jinnam KIM, Yongin-si (KR); Heejae EOM, Yongin-si (KR); Keonhee JEONG, Yongin-si (KR); Taewoo KIM, Yongin-si (KR); Yeokyeong SHIN, Yongin-si (KR); Cheolan KIM, Yongin-si (KR); Taesoo KIM, Yongin-si (KR)

(21) Appl. No.: 18/817,378

(22) Filed: Aug. 28, 2024

(30) Foreign Application Priority Data
Oct. 5, 2023 (KR) 10-2023-0132751

(51) Int. Cl. G02B 6/14; G01M 11/02; G02B 6/26; H01M 10/04

(52) U.S. Cl. CPC G02B 6/14; G01M 11/0207; G01M 11/025; G02B 6/264; H01M 10/0404

(57) ABSTRACT

A device for converting a single beam of a single mode to a multi single beam of a multi single mode, the device including an input fiber configured to input the single beam of the single mode, a collimating lens within a housing connected to the input fiber and configured to convert the single beam of the single mode to the multi single beam of the multi single mode to be directed in parallel while passing the single beam of the single mode inputted to an inlet of the housing, a focusing lens within the housing configured to collect the multi single beam of the multi single mode via the collimating lens to be directed to an outlet of the housing, and an output fiber connected to the outlet of the housing configured to output the multi single beam of the multi single mode.

### CROSS-REFERENCE TO RELATED APPLICATION

This application claims priority to and the benefit of Korean Patent Application No. 10-2023-0132751 filed in the Korean Intellectual Property Office on Oct. 5, 2023, the entire contents of which are incorporated herein by reference.

### BACKGROUND

### 1 Field

Embodiments of the present disclosure relate to a method and device for converting a single beam of a single mode to a multi single beam of a multi single mode, a multi single beam converted by the method, a method for measuring the multi single beam, and a rechargeable battery welded with the multi single beam.

### 2. Description of the Related Art

Recently, in response to industrial demands, the development of batteries with high energy density and safety has been actively conducted. For example, lithium-ion batteries have been put into practical use not only in the fields of information-related devices and communication devices, but also in the automobile field. Since the automobile field relates to life, safety is particularly important.

Lithium-ion batteries which are currently commercialized use an electrolyte containing a flammable organic solvent, so that there is a possibility of overheating and fires if a short circuit occurs. Thus, batteries without the flammable organic solvent are desirable.

The above-described information disclosed in the background art of the disclosure is only for improving understanding of the background of the present disclosure.

### SUMMARY

Embodiments include a device for converting a single beam of a single mode to a multi single beam of a multi single mode. The device includes an input fiber configured to input the single beam of the single mode, a collimating lens within a housing connected to the input fiber and configured to convert the single beam of the single mode to the multi single beam of the multi single mode to be directed in parallel while passing the single beam of the single mode inputted to an inlet of the housing, a focusing lens within the housing and configured to collect the multi single beam of the multi single mode via the collimating lens to be directed to an outlet of the housing, and an output fiber connected to the outlet of the housing and configured to output the multi single beam of the multi single mode.

A magnification factor (M) of a magnification (f_{foc}) of the focusing lens to a magnification (f_{coll}) of the collimating lens may be expressed by an equation M=f_{foc}/f_{coll}, and the magnification factor (M) may be 1.2 to 1.8.

The collimating lens may include a single lens, and a plurality of focusing lenses may be provided sequentially in parallel.

The device may further include a propagation fiber situated between the outlet of the housing and the output fiber, wherein the propagation fiber selects a guided beam and an unguided beam at a predetermined angle from the multi single beam of the multi single mode.

The input fiber may transmit the single beam of the single mode through a material having a first refractive index, and the housing may transmit the multi single beam of the multi single mode through a material having a second refractive index higher than the first refractive index.

The multi single beam of the multi single mode includes a single portion that has a reduced multi single mode, a decreased phase difference and a homogeneous density while transmitting a single beam of a single mode through a material having a first refractive index and transmitting the single beam through a material having a second refractive index higher than the first refractive index, and a plurality of multi portions formed in the single portion.

If viewed from a side, the multi portions may form a plurality of peaks and valleys.

If viewed from a plane, the multi portions may form a speckle shape by the plurality of peaks and valleys.

Embodiments include a method for measuring a multi single beam of a multi single mode. The method includes scanning a multi single beam of a multi single mode converted from a single beam of a single mode through a rotation measuring tip in a 3D measuring cylinder, transmitting the multi single beam of the multi single mode to a deflection mirror and measuring a spatial power density distribution and a shape of the multi single beam of the multi single mode in a focus range of an optical device, and transmitting the multi single beam of the multi single mode to a detector configured according to an output and a wavelength thereof.

The scanning may include measuring the multi single beam of the multi single mode through a rotation measuring tip having an opening tip.

Embodiments include a rechargeable battery welded with a multi single beam of a multi single mode converted from a single beam of a single mode, the rechargeable battery including a case including an electrode assembly, and a cap plate welded by sealing an opening of the case, wherein the case and the cap plate are welded with a multi single beam of a multi single mode converted from a single beam of a single mode to form a welding portion, and wherein the welding portion further includes a reinforcing portion protruding more than an outer surface of the cap plate.

A first length from a welding depth of the welding portion to the outer surface of the case and a second length from the welding depth to the outer surface of the cap plate may be set, and the first length may be smaller than the second length.

The welding portion including the reinforcing portion may have a width (W) set in a direction parallel to the cap plate, and a height (H) set in a direction parallel to the case, and a ratio (W/H) of the width (W) to the height (H) may be 0.5 to 2.0.

The welding portion may include equiaxed tear-shaped beads.

The equiaxed tear-shaped beads may include a plurality of beads having a width smaller than the width in a width direction with respect to the entire width of the welding portion.

The reinforcing portion may protrude 5 μm to 200 μm more than the outer surface of the cap plate.

### BRIEF DESCRIPTION OF THE DRAWINGS

Features will become apparent to those of ordinary skill in the art by describing in detail exemplary embodiments with reference to the attached drawings, in which:

FIG. 1 is a longitudinal cross-sectional diagram of an all-solid-state rechargeable battery according to one or more embodiments of the present disclosure;

FIG. 2 is a longitudinal cross-sectional diagram illustrating a lithium metal layer formed in the all-solid-state rechargeable battery according to one or more embodiments of the present disclosure;

FIG. 3 is a stereoscopic image of a single beam of a single mode used in a method and device for converting a single beam of a single mode into a multi single beam of a multi single mode according to one or more embodiments of the present disclosure;

FIG. 4 is a stereoscopic image of a multi single beam of a multi single mode converted by the method and device for converting a single beam of a single mode into a multi single beam of a multi single mode according to one or more embodiments of the present disclosure;

FIG. 5 is a planar image of a multi single beam of a multi single mode converted by the method and device for converting for converting a single beam of a single mode into a multi single beam of a multi single mode according to one or more embodiments of the present disclosure;

FIG. 6 is a schematic diagram of a device for converting a single beam of a single mode into a multi single beam of a multi single mode according to one or more embodiments of the present disclosure;

FIG. 7 illustrates dispersing a beam during a process of converting the single beam of the single mode to the multi single beam of the multi single mode between a collimating lens and a focusing lens within the device of FIG. 6 according to one or more embodiments of the present disclosure;

FIG. 8 illustrates collecting a beam during a process of converting the single beam of the single mode to the multi single beam of the multi single mode, while passing through the focusing lens of FIG. 7 according to one or more embodiments of the present disclosure;

FIG. 9 is a perspective view of a propagation fiber illustrating a state in which the single beam of the single mode is converted while passing through the focusing lens of FIG. 8 and propagated according to one or more embodiments of the present disclosure;

FIG. 10 is a cross-sectional view of FIG. 9 according to one or more embodiments of the present disclosure;

FIG. 11 is a flowchart of a method for converting for converting a single beam of a single mode into a multi single beam of a multi single mode according to one or more embodiments of the present disclosure;

FIGS. 12 to 15 are perspective views (a) and plan views (b) of a multi single beam of a multi single mode converted by the device and method for converting a single beam of a single mode to a multi single beam of a multi single mode according to one or more embodiments of the present disclosure;

FIG. 16 is a schematic diagram of a device for measuring a multi single beam of a multi single mode converted by the device and method for converting a single beam of a single mode into a multi single beam of a multi single mode according to one or more embodiments of the present disclosure;

FIG. 17 is a flowchart of a method for measuring a multi single beam of a multi single mode using the device of FIG. 16 according to one or more embodiments of the present disclosure;

FIG. 18 is a state diagram of a multi single beam welded with the multi single beam of the multi single mode converted by the device and method for converting a single beam of a single mode into a multi single beam of a multi single mode according to one or more embodiments of the present disclosure;

FIG. 19 is a perspective view of a rechargeable battery in which a cap plate and a case are welded with the multi single beam of the multi single mode of FIG. 18 according to one or more embodiments of the present disclosure;

FIG. 20 is a side image of the welding portion in FIG. 19 according to one or more embodiments of the present disclosure;

FIG. 21 is a planar image of the welding portion in FIG. 19 according to one or more embodiments of the present disclosure; and

FIG. 22 is a cross-sectional image of the welding portion taken along line A-A of FIG. 21 according to one or more embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those of ordinary skill in the art.

In the drawing figures, the dimensions of layers and regions may be exaggerated for clarity of illustration. It will also be understood that if a layer or element is referred to as being “on” another layer or substrate, it can be directly on the other layer or substrate, or intervening layers may also be present. Further, it will be understood that if a layer is referred to as being “under” another layer, it can be directly under, and one or more intervening layers may also be present. In addition, it will also be understood that if a layer is referred to as being “between” two layers, it can be the only layer between the two layers, or one or more intervening layers may also be present.

Hereinafter, embodiments of the present disclosure will be described in detail with reference to the accompanying drawings so as to easily implement by those of ordinary skill in the art. As those skilled in the art would realize, the described embodiments may be modified in various different ways, all without departing from the spirit or scope of the present disclosure.

In addition, unless explicitly described to the contrary, the word “comprise”, and variations such as “comprises” or “comprising”, will be understood to imply the inclusion of stated elements but not the exclusion of any other elements.

In the drawings, the thickness may be enlarged to clearly express various layers and regions, and like reference numerals designate like elements throughout the specification. If a certain part of a layer, a film, a region, a substrate, etc., is located “above” or “on” the other part, it is meant that not only the certain part is located “directly on” the other part, but also another part is interposed therebetween. In contrast, if an element is referred to as being “directly on” another element, there are no intervening elements present.

Also, here, “layer” includes not only a shape formed on the entire surface, but also a shape formed on a partial surface, if observed in a plan view. Here, “or” is not interpreted in an exclusive sense. For example, “A or B” is interpreted as including A, B, A+B, etc.

Positive Electrode for all-Solid-State Rechargeable Battery

In one or more embodiments, there is provided a positive electrode for an all-solid-state rechargeable battery including a current collector, and a positive active material layer located on the current collector, in which the positive active material layer includes at least one of a positive active material, a sulfide-based solid electrolyte, a binder, and a conductive material. However, the positive active material layer is not limited thereto, and the positive electrode for the all-solid-state rechargeable battery may include more or fewer components than the components described above.

In one or more embodiments, the positive electrode for the all-solid-state rechargeable battery may be manufactured by applying and then drying and rolling a positive electrode composition including at least one of the positive active material, the sulfide-based solid electrolyte, the binder, and the conductive material to the current collector.

### Positive Active Material

The positive active material can be applied without limitation as long as it is commonly used in all-solid-state rechargeable batteries. For example, the positive active material may be a compound capable of reversible intercalation and deintercalation of lithium and may include a compound represented by any one of the following Chemical Formulas.

LiₐA_{1-b}X_{b}D₂(0.90≤a≤1.8,0≤b≤0.5);

LiₐA_{1-b}X_{b}O_{2-c}D_{c}(0.90≤a≤1.8,0≤b≤0.5,0≤c≤0.05);

LiₐE_{1-b}X_{b}O_{2-c}D_{c}(0.90≤a≤1.8,0≤b≤0.5,0≤c≤0.05);

LiₐE_{2-b}X_{b}O_{4-c}D_{c}(0.90≤a≤1.8,0≤b≤0.5,0≤c≤0.05);

LiₐNi_{1-b-c}Co_{b}X_{c}D_{α}(0.90≤a≤1.8,0≤b≤0.5,0≤c≤0.5,0<a≤2);

LiₐNi_{1-b-c}Co_{b}X_{c}O_{2-α}T_{α}(0.90≤a≤1.8,0≤b≤0.5,0≤c≤0.05,0<α<2);

LiₐNi_{1-b-c}Co_{b}X_{c}O_{2-α}T₂(0.90≤a≤1.8,0≤b≤0.5,0≤c≤0.05,0<α<2);

LiₐNi_{1-b-c}Mn_{b}X_{c}D_{α}(0.90≤a≤1.8,0≤b≤0.5,0≤c≤0.05,0<α<2);

LiₐNi_{1-b-c}Mn_{b}X_{c}O_{2-α}T_{α}(0.90≤a≤1.8,0≤b≤0.5,0≤c≤0.05,0<α<2);

LiₐNi_{1-b-c}Mn_{b}X_{c}O_{2-α}T₂(0.90≤a≤1.8,0≤b≤0.5,0≤c≤0.05,0<α<2);

LiₐNi_{b}E_{c}G_{d}O₂(0.90≤a≤1.8,0≤b≤0.9,0≤c≤0.5,0.001≤d≤0.1);

LiₐNi_{b}Co_{c}Mn_{d}GₑO₂(0.90≤a≤1.8,0≤b≤0.9,0≤c≤0.5,0≤d≤0.5,0.001≤e≤0.1);

LiₐNiG_{b}O₂(0.90≤a≤1.8,0.001≤b≤0.1);

LiₐCoG_{b}O₂(0.90≤a≤1.8,0.001≤b≤0.1);

LiₐMn_{1-b}G_{b}O₂(0.90≤a≤1.8,0.001≤b≤0.1);

LiₐMn₂G_{b}O₄(0.90≤a≤1.8,0.001≤b≤0.1);

LiₐMn_{1-g}G_{g}PO₄(0.90≤a≤1.8,0≤g≤0.5);
QO₂; QS₂; LiQS₂;
V₂O₅; LiV₂O₅;
LiZO₂;
LiNiVO₄;

Li_{(3-f)}J₂PO₄₃(0≤f≤2);

Li_{(3-f)}Fe₂PO₄₃(0≤f≤2); and

LiₐFePO₄(0.90≤a≤1.8).

In the Chemical Formulas above, A is selected from Ni, Co, Mn, and a combination thereof; X may be selected from Al, Ni, Co, Mn, Cr, Fe, Mg, Sr, V, rare earth elements, and a combination thereof; D may be selected from O, F, S, P, and a combination thereof; E may be selected from Co, Mn, and a combination thereof; T may be selected from F, S, P, and a combination thereof; G may be selected from Al, Cr, Mn, Fe, Mg, La, Ce, Sr, V, and a combination thereof; Q may be selected from Ti, Mo, Mn, and a combination thereof; Z may be selected from Cr, V, Fe, Sc, Y, and a combination thereof; and J may be selected from V, Cr, Mn, Co, Ni, Cu, and a combination thereof.

The positive active material may be, for example, lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), or lithium iron phosphate (LFP).

The positive active material may include a lithium nickel-based oxide represented by Chemical Formula 1 below, a lithium cobalt-based oxide represented by Chemical Formula 2 below, a lithium iron phosphate-based compound represented by Chemical Formula 3 below, or a combination thereof.

Lia1Nix1M1y1M21−x1−y1O2 [Chemical Formula 1]

In Chemical Formula 1, 0.9≤a1≤1.8, 0.3≤x1≤1, 0≤y1≤0.7, and M¹ and M² are each independently one or more elements selected from Al, B, Ba, Ca, Ce, Co, Cr, Cu, F, Fe, Mg, Mn, Mo, Nb, P, S, Si, Sr, Ti, V, W, and Zr.

Lia2Cox2M31−x2O2 [Chemical Formula 2]

In Chemical Formula 2, 0.9≤a2≤1.8, 0.6≤x2≤1, and M³ is at least one of Al, B, Ba, Ca, Ce, Cr, Cu, F, Fe, Mg, Mn, Mo, Nb, P, S, Si, Sr, Ti, V, W, and Zr.

Lia3Fex3M41−x3PO₄ [Chemical Formula 3]

In Chemical Formula 3, 0.9≤a3≤1.8, 0.6≤x3≤1, and M⁴ is at least one of Al, B, Ba, Ca, Ce, Co, Cr, Cu, F, Fe, Mg, Mn, Mo, Nb, P, S, Si, Sr, Ti, V, W, and Zr.

An average particle diameter D50 of the positive active material may be 1 μm to 25 μm, for example, 3 μm to 25 μm, 5 μm to 25 μm, 5 μm to 20 μm, 8 μm to 20 μm, or 10 μm to 18 μm. The positive active material having such a particle size range may be harmoniously mixed with other components in the positive active material layer and may achieve high capacity and high energy density.

The positive active material may be in the form of secondary particles made by agglomerating a plurality of primary particles or may be in the form of single particles. In addition, the positive active material may be spherical or close to a spherical shape or may be polyhedral or amorphous.

### Sulfide-Based Solid Electrolyte

The sulfide-based solid electrolyte may include, for example, Li₂S—P₂S₅, Li₂S—P₂S₅—LiX (X is a halogen element, for example, I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are each an integer, and Z is Ge, Zn or Ga), Li₂S—GeS₂, Li₂S—SiS₂—Li₃PO₄, Li₂S—SiS₂-LiₚMO_{q} (p and q are integers, and M is P, Si, Ge, B, Al, Ga or In), or a combination thereof.

Such a sulfide-based solid electrolyte may be obtained, for example, by mixing Li₂S and P₂S₅ at a molar ratio of 50:50 to 90:10, respectively, or 50:50 to 80:20, and optionally heat-treating the mixture. Within the mixing ratio range, the sulfide-based solid electrolyte having excellent ionic conductivity may be manufactured. Here, ion conductivity may be further improved by additionally including SiS₂, GeS₂, B₂S₃, etc. as other components.

A mechanical milling or solution method may be applied as a method of mixing sulfur-containing raw materials to manufacture the sulfide-based solid electrolyte. The mechanical milling is a method of adding starting materials, a ball mill, etc. in a reactor and atomizing and mixing the starting materials by stirring strongly. If using the solution method, a solid electrolyte may be obtained as a deposit by mixing the starting materials in a solvent. In addition, if heat treatment is performed after mixing, the crystals of the solid electrolyte may be further hardened, and ionic conductivity may be improved. As an example, the sulfide-based solid electrolyte may be manufactured by mixing sulfur-containing raw materials and heat-treating the raw materials two or more times. In this case, a sulfide-based solid electrolyte with high ionic conductivity and robustness may be manufactured.

As an example, the sulfide-based solid electrolyte particles may include argyrodite-type sulfide. The argyrodite-type sulfide may be represented by a Chemical Formula of for example, LiₐM_{b}P_{c}S_{d}Aₑ (a, b, c, d and e are all 0 or more and 12 or less, M is a metal excluding Li or a combination of a plurality of metals excluding Li, and A is F, Cl, Br, or I), specifically Li₇₋ₓPS₆₋ₓAₓ (x is 0.2 or more and 1.8 or less, and A is F, Cl, Br, or I). The argyrodite-type sulfide may be, specifically, Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, etc.

Sulfide-based solid electrolyte particles containing such argyrodite-type sulfide have high ionic conductivity close to the range of 10⁻⁴ to 10⁻² S/cm, which is ionic conductivity of a general liquid electrolyte at room temperature, may form a close bond between the positive active material and the solid electrolyte without causing a decrease in ionic conductivity, and may further form a tight interface between an electrode layer and a solid electrolyte layer. All-solid-state batteries containing the materials may have improved battery performance, such as rate characteristics, coulombic efficiency, and lifespan characteristics.

The argyrodite-type sulfide-based solid electrolyte may be manufactured by mixing, for example, sulfide lithium and phosphorus sulfide, selectively halogenated lithium. The materials may be mixed and then heat-treated. The heat treatment may include, for example, two or more heat treatment steps.

In some embodiments, an average particle diameter D50 of the sulfide-based solid electrolyte particles according to an embodiment may be 5.0 μm or less, for example, 0.1 μm to 5.0 μm, 0.1 μm to 4.0 μm, 0.1 μm to 3.0 μm, 0.5 μm to 2.0 μm, or 0.1 μm to 1.5 μm. In other embodiments, the sulfide-based solid electrolyte particles may be small particles having an average particle diameter D50 of 0.1 μm to 1.0 μm depending on the location or purpose of use, or large particles having an average particle diameter D50 of 1.5 μm to 5.0 μm. The sulfide-based solid electrolyte particles in the particle size range may effectively penetrate between solid particles in the battery and have excellent conductivity with the electrode active materials and connectivity between solid electrolyte particles. The average particle diameter of the sulfide-based solid electrolyte particles may be measured with a microscope image. For example, D50 may be calculated by measuring the sizes of about 20 particles in a scanning electron microscope image to obtain a particle size distribution.

In the positive electrode for the all-solid-state battery, the content of the solid electrolyte may be 0.5 wt % (percentage by weight) to 35 wt %, for example, 1 wt % to 35 wt %, 5 wt % to 30 wt %, 8 wt % to 25 wt %, or 10 wt % to 20 wt %. The content is the content to the total weight of components in the positive electrode, and specifically, may be referred to as the content to the total weight of the positive active material layer.

In an embodiment, the positive active material layer may include 50 wt % to 99.35 wt % of the positive active material, 0.5 wt % to 35 wt % of the sulfide-based solid electrolyte, 0.1 wt % to 10 wt % of a fluorinated resin binder, and 0.05 wt % to 5 wt % of vanadium oxide with respect to 100 wt % of the positive active material layer. If the content range is satisfied, the positive electrode for the all-solid-state rechargeable battery maintains high adhesion while implementing high capacity and high ionic conductivity and maintains the viscosity of the positive electrode composition at an appropriate level, thereby improving processability.

### Binder

The binder serves to attach the positive active material particles to each other well and attach the positive active material to the current collector well. Representative examples thereof may include polyvinyl alcohol, carboxymethyl cellulose, hydroxypropyl cellulose, diacetyl cellulose, polyvinyl chloride, carboxylated polyvinyl chloride, polyvinyl fluoride, polymers containing ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, nylon, etc., but are not limited thereto.

### Conductive Material

The positive active material layer may further include a conductive material. The conductive material is used to provide conductivity to the electrode, and may include, for example, carbon-based materials such as natural graphite, artificial graphite, carbon black, acetylene black, KETJENBLACK, carbon fiber, and carbon nanotubes; metallic materials containing copper, nickel, aluminum, silver, etc. and in the form of metal powder or metal fiber; conductive polymers such as polyphenylene derivatives, etc.; or a combination thereof.

The conductive material may be included in an amount of 0.1 wt % to 5 wt %, or 0.1 wt % to 3 wt %, based on the total weight of each component of the positive electrode for the all-solid-state battery, or based on the total weight of the positive active material layer. Within the content range, the conductive material may improve electrical conductivity without deteriorating battery performance.

If the positive active material layer further includes the conductive material, the positive active material layer may include 45 wt % to 99.25 wt % of the positive active material, 0.5 wt % to 35 wt % of the sulfide-based solid electrolyte, 0.1 wt % to 10 wt % of the fluorinated resin binder, 0.05 wt % to 5 wt % of vanadium oxide, and 0.1 wt % to 5 wt % of the conductive material, with respect to total 100 wt % of the positive active material layer.

Meanwhile, the positive electrode for the lithium rechargeable battery may also include an oxide-based inorganic solid electrolyte other than the solid electrolyte described above. The oxide-based inorganic solid electrolyte may include, for example, Li₁₊ₓTi₂₋ₓAl PO₄₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃(PLZT) (0≤x<1, 0≤y<1), PB (Mg₃Nb_{2/3}) O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y} PO₄₃, 0<x<2, 0<y<3), Li_{1+x+y} (Al, Ga)ₓ(Ti, Ge)₂₋ₓ Si_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (M=Te, Nb, or Zr; x is an integer from 1 to 10), or a combination thereof.

### All-Solid-State Rechargeable Battery

In one or more embodiments, there is provided an all-solid-state rechargeable battery including the above-described positive electrode, a negative electrode, and a solid electrolyte layer located between the positive electrode and the negative electrode. The all-solid-state rechargeable battery may also be referred to as an all-solid-state battery, or an all-solid lithium rechargeable battery.

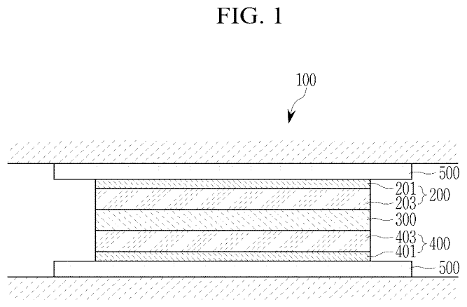

FIG. 1 is a cross-sectional view of an all-solid-state rechargeable battery according to one or more embodiments of the present disclosure. Referring to FIG. 1, an all-solid-state rechargeable battery 100 may have a structure in which a case such as a pouch, etc. includes an electrode assembly stacked with a negative electrode 400 including a negative current collector 401 and a negative active material layer 403, a solid electrolyte layer 300, and a positive electrode 200 including a positive active material layer 203 and a positive current collector 201. The all-solid-state rechargeable battery 100 may further include an elastic layer 500 outside at least one of the positive electrode 200 and the negative electrode 400. In FIG. 1, one electrode assembly including the negative electrode 400, the solid electrolyte layer 300, and the positive electrode 200 has been illustrated, but an all-solid-state battery may also be fabricated by stacking two or more electrode assemblies.

### Negative Electrode

The negative electrode for the all-solid-state battery may include, for example, a current collector and a negative active material layer located on the current collector. The negative active material layer may include a negative active material, and may further include a binder, a conductive material, and/or a solid electrolyte.

The negative active material may include a material capable of reversibly intercalating/deintercalating lithium ions, lithium metal, an alloy of lithium metal, a material capable of being doped or dedoped in lithium or a transition metal oxide.

The material capable of reversibly intercalating/deintercalating the lithium ions may be a carbon-based negative active material, and may include, for example, crystalline carbon, amorphous carbon, or a combination thereof. Examples of the crystalline carbon may include graphite such as amorphous, plate-shaped, flake, spherical or fibrous natural graphite or artificial graphite, and examples of the amorphous carbon may include soft carbon or hard carbon, mesophase pitch carbide, calcined coke, etc.

The alloy of the lithium metal may be used with an alloy of lithium and at least one of Na, K, Rb, Cs, Fr, Be, Mg, Ca, Sr, Si, Sb, Pb, In, Zn, Ba, Ra, Ge, Al and Sn.

The material capable of being doped or dedoped in lithium may be used with a Si-based negative active material or a Sn-based negative active material. The Si-based negative active material may include silicon, a silicon-carbon composite, SiOx (0<x<2), and an Si-Q alloy (the Q is an element selected from an alkali metal, alkaline earth metal, Group 13 element, Group 14 element, Group 15 element, Group 16 element, transition metals, rare earth element, and a combinations thereof, but not Si). The Sn-based negative active material may include Sn, SnO₂, an Sn—R alloy (the R is an element selected from an alkali metal, alkaline earth metal, Group 13 element, Group 14 element, Group 15 element, Group 16 element, transition metal, rare earth element and a combination thereof, but not Sn), etc. In addition, the material may also be used by mixing at least one thereof and SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and combinations thereof.

For example, the silicon-carbon composite may be, for example, a silicon-carbon composite including a core including crystalline carbon and silicon particles and an amorphous carbon coating layer located on the surface of the core. The crystalline carbon may be artificial graphite, natural graphite, or a combination thereof. As the amorphous carbon precursor, coal-based pitch, mesophase pitch, petroleum-based pitch, coal-based oil, petroleum-based heavy oil, or polymer resin such as phenol resin, furan resin, and polyimide resin may be used. At this time, the content of silicon may be 10 wt % to 50 wt % based on the total weight of the silicon-carbon composite. In addition, the content of the crystalline carbon may be 10 wt % to 70 wt % based on the total weight of the silicon-carbon composite, and the content of the amorphous carbon may be 20 wt % to 40 wt % based on the total weight of the silicon-carbon composite. Additionally, the thickness of the amorphous carbon coating layer may be 5 nm to 100 nm.

The average particle diameter D50 of the silicon particles may be 10 nm to 20 μm, for example, 10 nm to 500 nm. The silicon particles may exist in an oxidized form, and in this case, the atomic content ratio of Si:O in the silicon particles, which indicates the degree of oxidation, may be 99:1 to 33:67, respectively. The silicon particles may be SiOx particles, and in this case, the x range in SiOx may be greater than 0 and less than 2. The average particle diameter D50 may be measured with a particle size analyzer using a laser diffraction method and means a diameter of particles with a cumulative volume of 50 vol % in the particle size distribution.

The Si-based negative active material or Sn-based negative active material may be mixed and used with a carbon-based negative active material. A mixing ratio of the Si-based negative active material or Sn-based negative active material; and the carbon-based negative active material may be a weight ratio of 1:99 to 90:10, respectively.

The content of the negative electrode active material in the negative electrode active material layer may be 95 wt % to 99 wt % based on the total weight of the negative electrode active material layer.

In one or more embodiments, the negative active material layer may further include a binder and selectively, may further include a conductive material. The content of the binder in the negative active material layer may be 1 wt % to 5 wt % based on the total weight of the negative active material layer. In addition, if further including the conductive material, the negative active material layer may include 90 wt % to 98 wt % of the negative active material, 1 wt % to 5 wt % of the binder, and 1 wt % to 5 wt % of the conductive material.

The binder serves to attach the negative active material particles to each other well and also to attach the negative active material to the current collector well. The binder may include a water-insoluble binder, a water-soluble binder, or a combination thereof.

The non-water-soluble binder may include, for example, polyvinyl chloride, carboxylated polyvinyl chloride, polyvinyl fluoride, polymer containing ethylene oxide, ethylene propylene copolymer, polystyrene, polyvinylpyrrolidone, polyurethane, polytetrafluoroethylene, polyvinylidene fluoride, polyethylene, polypropylene, polyamideimide, polyimide, or a combination thereof.

The water-soluble binder may include a rubber binder or a polymer resin binder. The rubber-based binder may be selected from styrene-butadiene rubber, acrylated styrene-butadiene rubber, acrylonitrile-butadiene rubber, acrylic rubber, butyl rubber, fluorine rubber, and a combination thereof. The polymer resin binder may be selected from polyethylene oxide, polyvinylpyrrolidone, polyepichlorohydrin, polyphosphazene, polyacrylonitrile, ethylene propylene diene copolymer, polyvinylpyridine, chlorosulfonated polyethylene, latex, polyester resin, acrylic resin, phenol resin, epoxy resin, polyvinyl alcohol, and combinations thereof.

If the water-soluble binder is used as the negative electrode binder, a thickener capable of imparting the viscosity may be used together, and the thickener may include, for example, a cellulose-based compound. The cellulose-based compound may include carboxymethyl cellulose, hydroxypropylmethyl cellulose, methyl cellulose, alkali metal salts thereof, or combinations thereof. The alkali metal may be used with Na, K or Li. The amount of the thickener used may be 0.1 to 3 parts by weight based on 100 parts by weight of the negative active material.

The conductive material is used to provide conductivity to the electrode, and may include, for example, carbon-based materials such as natural graphite, artificial graphite, carbon black, acetylene black, KETJENBLACK, carbon fiber, and carbon nanotubes; metallic materials containing copper, nickel, aluminum, silver, etc. and in the form of metal powder or metal fiber; conductive polymers such as polyphenylene derivatives, etc.; or a combination thereof.

The negative current collector may be selected from copper foil, nickel foil, stainless steel foil, titanium foil, nickel foam, copper foam, a polymer substrate coated with a conductive metal, and combinations thereof.

As another example, the negative electrode for the all-solid-state battery may be a deposition-type negative electrode. The deposition-type negative electrode refers to a negative electrode in which a negative active material is not included during battery assembly, but lithium metal, etc. is deposited during battery charging to serve as a negative active material.

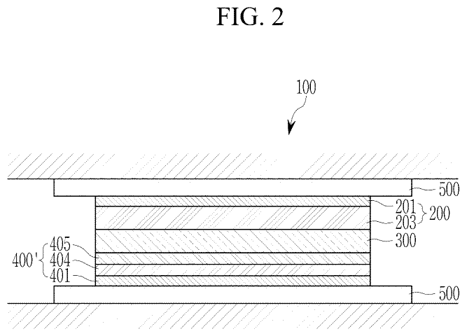

FIG. 2 is schematic cross-sectional view of an all-solid-state rechargeable battery including a deposition-type negative electrode according to one or more embodiments. Referring to FIG. 2, the deposition-type negative electrode 400′ may include a current collector 401 and a negative electrode coating layer 405 located on the current collector. In the all-solid-state battery having such a deposition-type negative electrode 400′, initial charging may begin in the absence of the negative electrode active material, and during charging, high-density lithium metal, etc. may be deposited between the current collector 401 and the negative electrode coating layer 405 to form a lithium metal layer 404, which may serve as a negative active material. Accordingly, in the all-solid-state battery that has been charged at least once, the deposition-type negative electrode 400′ includes a current collector 401, a lithium metal layer 404 located on the current collector, and a negative electrode coating layer 405 located on the metal layer. The lithium metal layer 404 refers to a layer in which lithium metal, etc. is deposited during the charging process of the battery and may be referred to as a metal layer or a negative active material layer.

The negative electrode coating layer 405 may include metal, carbon material, or a combination thereof that acts as a catalyst.

The metal may include, for example, gold, platinum, palladium, silicon, silver, aluminum, bismuth, tin, zinc, or a combination thereof, and may also consist of one of these or several types of alloys. If the metal exists in a particle form, an average particle diameter D50 may be about 4 μm or less, for example, 10 nm to 4 μm.

The carbon material may be, for example, crystalline carbon, amorphous carbon, or a combination thereof. The crystalline carbon may be, for example, natural graphite, artificial graphite, mesophase carbon microbeads, or a combination thereof. The amorphous carbon may be, for example, carbon black, activated carbon, acetylene black, Denka black, KETJENBLACK, or a combination thereof.

If the negative electrode coating layer 405 includes both the metal and the carbon material, the mixing ratio of the metal and the carbon material may be, for example, a weight ratio of 1:10 to 2:1, respectively. In this case, the deposition of lithium metal may be effectively promoted, and the characteristics of the all-solid-state battery may be improved. For example, the negative electrode coating layer 405 may include, for example, a carbon material on which a catalyst metal is supported or may include a mixture of metal particles and carbon material particles.

As another example, the negative electrode coating layer 405 may include the metal and amorphous carbon, and in this case, may effectively promote deposition of lithium metal.

The negative electrode coating layer 405 may further include a binder, and the binder may be a conductive binder. In addition, the negative electrode coating layer 405 may further include general additives such as a filler, a dispersant, and an ion conductive material.

The thickness of the cathode coating layer 405 may be, for example, 100 nm to 20 μm, or 500 nm to 10 μm, or 1 μm to 5μ m.

For example, the deposition-type negative electrode 400′ may further include a thin film on the surface of the current collector, that is, between the current collector and the negative electrode coating layer. The thin film may contain an element that may form an alloy with lithium. The element that may form an alloy with lithium may be, for example, gold, silver, zinc, tin, indium, silicon, aluminum, bismuth, etc., and may also consist of one type of these or several types of alloys. The thin film may further flatten the deposition form of the lithium metal layer 404 and further improve the characteristics of the all-solid-state battery. The thin film may be formed by a method such as vacuum deposition, sputtering, or plating. The thickness of the thin film may be, for example, 1 nm to 500 nm.

### Solid Electrolyte Layer

The solid electrolyte layer 300 may include a sulfide-based solid electrolyte, an oxide-based solid electrolyte, etc. The specific details of the sulfide-based solid electrolyte and the oxide-based solid electrolyte are as described above.

In one example, the solid electrolyte included in the positive electrode 200 and the solid electrolyte included in the solid electrolyte layer 300 may also include the same compound or different compounds. For example, if both the positive electrode 200 and the solid electrolyte layer 300 contain an argyrodite-type sulfide-based solid electrolyte, the overall performance of the all-solid-state rechargeable battery may be improved. In addition, as another example, if both the positive electrode 200 and the solid electrolyte layer 300 include the above-described coated solid electrolyte, the all-solid-state rechargeable battery may realize excellent initial efficiency and lifespan characteristics while realizing high capacity and high energy density.

Meanwhile, the average particle diameter D50 of the solid electrolyte included in the positive electrode 200 may be smaller than the average particle diameter D50 of the solid electrolyte included in the solid electrolyte layer 300. In this case, overall performance may be improved by maximizing the energy density of the all-solid-state battery and increasing the mobility of lithium ions. For example, the average particle diameter D50 of the solid electrolyte included in the positive electrode 200 may be 0.1 μm to 1.0 μm, or 0.1 μm to 0.8 μm, and the average particle diameter D50 of the solid electrolyte included in the solid electrolyte layer 300 may be 1.5 μm to 5.0 μm, or 2.0 μm to 4.0 μm, or 2.5 μm to 3.5 μm. If such a particle size range is satisfied, the energy density of the all-solid-state rechargeable battery may be maximized and the transfer of lithium ions may be facilitated, and thus resistance is suppressed, thereby improving the overall performance of the all-solid-state rechargeable battery. The average particle diameter D50 of the solid electrolyte may be measured through, for example, a particle size analyzer using a laser diffraction method. In addition, the D50 value may be calculated by selecting about 20 particles from a micrograph by a scanning electron microscope, etc., measuring the particle size, and obtaining the particle size distribution.

The solid electrolyte layer may further include a binder other than the solid electrolyte. The binder may be styrene butadiene rubber, polytetrafluoroethylene, polyvinylidene fluoride, polyethylene, acrylate-based polymer, or a combination thereof, but is not limited thereto, and may use any binder used as a binder in the technical field. The acrylate-based polymer may be, for example, butyl acrylate, polyacrylate, polymethacrylate, or a combination thereof.

The solid electrolyte layer may be formed by adding a solid electrolyte to a binder solution, coating the mixture on a base film, and drying the base film. The solvent for the binder solution may be isobutyryl isobutyrate, xylene, toluene, benzene, hexane, or a combination thereof. Since the solid electrolyte layer forming process is widely known in the art, detailed description thereof will be omitted.

The thickness of the solid electrolyte layer may be, for example, 10 μm to 150 μm.

The solid electrolyte layer may further include an alkali metal salt, and/or an ionic liquid, and/or a conductive polymer.

The alkali metal salt may be, for example, a lithium salt. The content of lithium salt in the solid electrolyte layer may be 1 M or more, for example, 1 M to 4 M. In this case, the lithium salt may improve ion conductivity by improving the lithium-ion mobility of the solid electrolyte layer.

The lithium salt may include, for example, LiSCN, LiN (CN)₂, Li (CF₃SO₂)₃C, LiC₄F₉SO₃, LIN (SO₂CF₂CF₃)₂, LiCl, LiF, LiBr, LiI, LiB C₂O₄₂, LiBF₄, LiBF₃C₂F₅, lithium bis(oxalato) borate (LiBOB), lithium difluoro (oxalato) borate (LiDFOB), lithium bis(trifluoro methanesulfonyl)imide (LiTFSI, LIN (SO₂CF₃)₂), fluorosulfonyl)imide (lithium bis(fluorosulfonyl)imide (LiFSI, LIN (SO₂F)₂), LiCF₃SO₃, LiAsF₆, LiSbF₆, LiClO₄ or a mixture thereof.

In addition, the lithium salt may be an imide-based lithium salt, and, for example, the imide-based lithium salt may include trifluoromethanesulfonyl)imide (lithium bis(trifluoro methanesulfonyl)imide (LiTFSI, LiN (SO₂CF₃)₂), and lithium bis(fluorosulfonyl)imide (LiFSI, LIN (SO₂F)₂). The lithium salt may maintain or improve ionic conductivity by maintaining appropriate chemical reactivity with an ionic liquid.

The ionic liquid refers to a salt or a room temperature molten salt that has a melting point below room temperature and consists of only ions in a liquid state at room temperature.

The ionic liquid may be a compound including a) at least one cation selected from ammoniums, pyrrolidiniums, pyridiniums, pyrimidiniums imidazoliums, piperidiniums, pyrazoliums, oxazoliums, pyridaziniums, phosphoniums, sulfoniums, triazoliums and mixtures thereof, and b) at least one anion selected from BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, FSO₂₂N—, (C₂F₅SO₂)₂N—, (C₂F₅SO₂, CF₃SO₂)N—, and (CF₃SO₂)₂N—.

The ionic liquid may be, for example, at least one of N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide and 1-ethyl-3-methylimidazolium bis(trifluoromethylsulfonyl)amide.

In the solid electrolyte layer, the weight ratio of the solid electrolyte and the ionic liquid may be 0.1:99.9 to 90:10, respectively, for example, 10:90 to 90:10, 20:80 to 90:10, 30:70 to 90:10, 40:60 to 90:10, or 50:50 to 90:10. The solid electrolyte layer that satisfies the above range may maintain or improve ionic conductivity by improving an electrochemical contact area with the electrode. Accordingly, the energy density, discharge capacity, rate characteristics, etc. of the all-solid-state battery may be improved.

The all-solid-state battery may be a unit cell having a structure of positive electrode/solid electrolyte layer/negative electrode, a bicell having a structure of positive electrode/solid electrolyte layer/negative electrode/solid electrolyte layer/positive electrode, or a stacked battery in which the structure of the unit cell is repeated.

The shape of the all-solid-state battery may be, for example, a coin shape, a button shape, a sheet shape, a stacked shape, a cylindrical shape, a flat shape, etc., but is not limited thereto. In addition, the all-solid-state battery may also be applied to large batteries used in electric vehicles, etc. For example, the all-solid-state battery may also be used in hybrid vehicles such as a plug-in hybrid electric vehicle (PHEV). In addition, the all-solid-state battery may be used in fields that require large amounts of power storage, for example, electric bicycles, power tools, or the like.

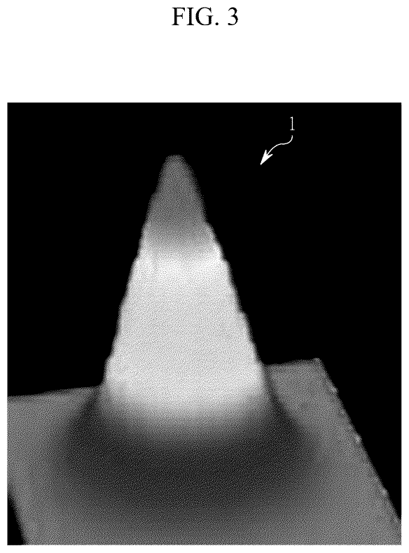

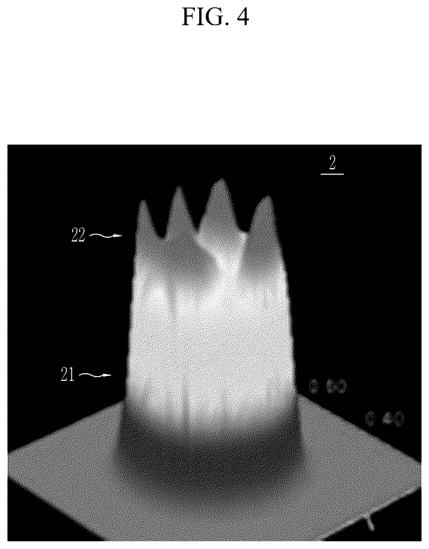

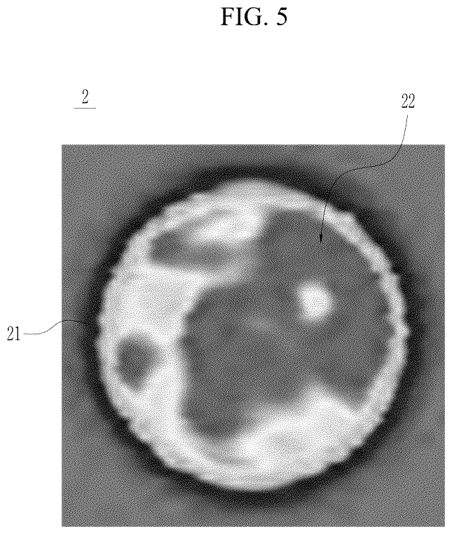

FIG. 3 is a stereoscopic image of a single beam of a single mode used in a method and device for converting a single beam of a single mode to a multi single beam of a multi single mode according to one or more embodiments of the present disclosure; FIG. 4 is a stereoscopic image of a multi single beam of a multi single mode converted by the method and device for converting a single beam of a single mode to a multi single beam of a multi single mode according to one or more embodiments of the present disclosure; and FIG. 5 is a planar image of a multi single beam of a multi single mode converted by the method and device for converting a single beam of a single mode to a multi single beam of a multi single mode according to one or more embodiments of the present disclosure.

Referring to FIGS. 3 and 4, a single beam 1 of a multi single mode may be converted from a single beam 1 of a single mode to a multi single beam 2 of a multi ingle mode includes a single portion 21 and a multi portion 22.

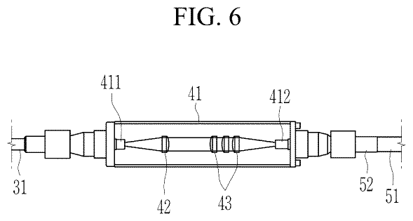

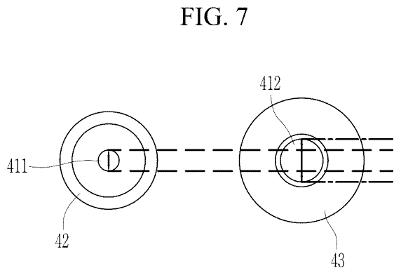

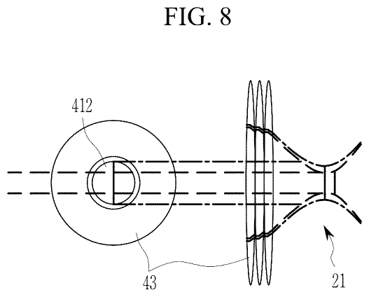

FIG. 6 is a schematic diagram of a device for converting a single beam of a single mode to a multi single beam of a multi single mode according to one or more embodiments of the present disclosure, FIG. 7 illustrates dispersing a beam during a process of converting the single beam of the single mode to the multi single beam of the multi single mode between a collimating lens and a focusing lens in the device of FIG. 6 according to one or more embodiments of the present disclosure, and FIG. 8 illustrates collecting a beam during a process of converting the single beam of the single mode to the multi single beam of the multi single mode, while passing through the focusing lens of FIG. 7 according to one or more embodiments of the present disclosure.

Referring to FIGS. 6 to 8, a device for converting a single beam to a multi single beam may include an input fiber 31, a housing 41, a collimating lens 42, a focusing lens 43, and an output fiber 51.

The input fiber 31 may be configured to input the single beam 1 of the single mode and may be connected to an inlet 411 of the housing 41. The output fiber 51 may be connected to an outlet 412 of the housing 41 and may be configured to output the multi single beam 2 of the multi single mode.

The device according to one or more embodiments may include a collimating lens 42 and a focusing lens 43 provided in the housing 41 as main parts. The collimating lens 42 may be formed as a concave lens and the focusing lens 43 may be formed as a convex lens.

The collimating lens 42 may disperse and convert the single beam 1 of the single mode to the multi single beam 2 of the multi single mode to be directed in parallel while passing the single beam 1 input to the inlet 411 of the housing 41. As an example, the collimating lens 42 may be provided in a singular form.

The focusing lens 43 may collect the multi single beam 2 of the multi single mode via the collimating lens 42 to be directed to the outlet 412. That is, the focusing lens 43 may increase the density of the multi single beam 2 of the multi single mode to be directed to the outlet 412. As an example, a plurality of focusing lenses 43 may be provided sequentially in parallel.

A magnification factor of a magnification (f_{foc}) of the focusing lens 43 to a magnification (f_{coll}) of the collimating lens 42 may be expressed by an equation M=f_{foc}/f_{coll}. The magnification factor M may be 1.2 to 1.8. As an example, if the magnification factor M is less than 1.2, the magnification (f_{foc}) of the focusing lens 43 may be too small and the density of the multi single beam 2 of the multi single mode may become too low, so that in the multi portion 22, the number of peaks and valleys may be too few.

If the magnification factor M is more than 1.8, the magnification (f_{foc}) of the focusing lens 43 may be too large and the density of the multi single beam 2 of the multi single mode may become too high, so that in the multi portion 22, the number of peaks and valleys may be too many.

If the magnification factor M is 1.2 to 1.8, the magnification (f_{foc}) of the focusing lens 43 may be appropriate, so that the density of the multi single beam 2 of the multi single mode may in turn become appropriate, and as a result, in the multi portion 22, the number of peaks and valleys may be appropriate. For example, the number of peaks may be appropriately 5 to 6.

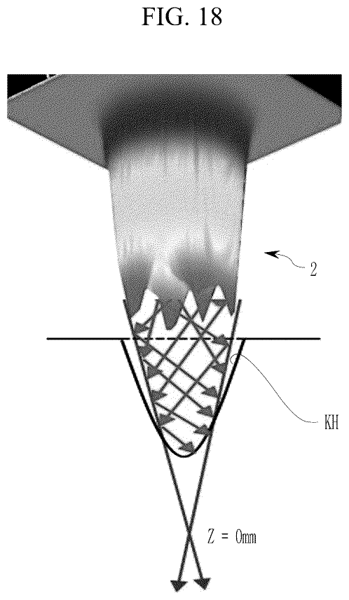

That is, the multi single beam 2 of the multi single mode with 5 to 6 peaks may stabilize a melting pool, and as a result, facilitate the discharge of gas and impurities from a keyhole (KH, see FIG. 18) during high-speed welding with a welding tool capable of outputting the multi single beam 2 of the multi single mode. Accordingly, the occurrence of pores in a welding portion may be reduced, and the quality of welding beads may be improved.

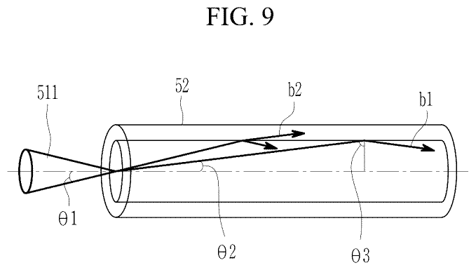

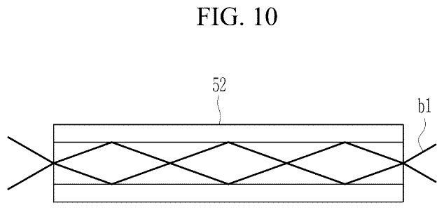

FIG. 9 is a perspective view of a propagation fiber illustrating a state in which the multi single beam of the multi single mode converted while passing through the focusing lens of FIG. 8 may be propagated according to one or more embodiments, and FIG. 10 is a cross-sectional view of FIG. 9 according to one or more embodiments.

Referring to FIGS. 9 and 10, a device of one or more embodiments may further include a propagation fiber 52 provided between the outlet 412 of the housing 41 and the output fiber 51. The propagation fiber 52 may select a guided beam b1 and an unguided beam b2 at a predetermined first angle θ1 in an acceptance cone 511 from the inputted multi single beam 2 of the multi single mode. Only the selected guided beam b1 is propagated to the output fiber 51 to be used for welding.

The multi single beam 2 of the multi single mode may be output at the predetermined first angle θ1 in the acceptance cone 511, converted to a second angle θ2 with respect to a central axis of the propagation fiber 52, and finally selected while converted at a third angle θ3 based on a perpendicular line on the inner surface of the propagation fiber 52.

The input fiber 31 may transmit the single beam 1 of the single mode through a material having a first refractive index. The housing 41 may transmit the converted multi single beam 2 of the multi single mode through a material having a second refractive index higher than the first refractive index. As illustrated in FIGS. 9 and 10, the multi single beam 2 of the multi single mode may be outputted as the guided beam b1 selected from the propagation fiber 52 and may be used for welding.

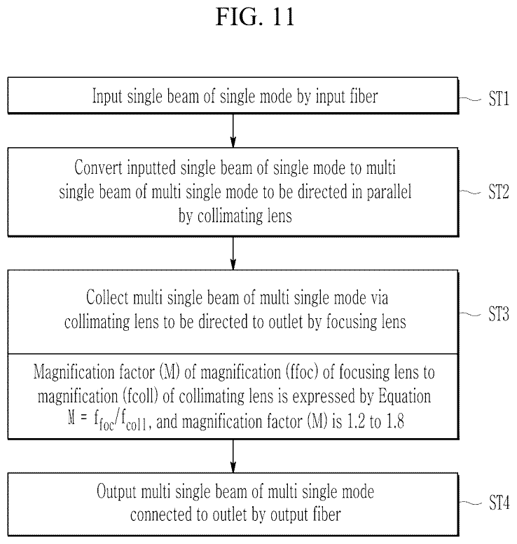

FIG. 11 is a flowchart of a method for converting a single beam of a single mode to a multi single beam of a multi single mode according to one or more embodiments of the present disclosure. Referring to FIG. 11, a method for converting a multi single beam from a single beam of one or more embodiments includes a first step ST1, a second step ST2, a third step ST3, and a fourth step ST4.

In the first step ST1, the single beam 1 of the single mode may be input to the inlet 411 of the housing 41 through the input fiber 31. In the second step ST2, through the collimating lens 42 within the housing 41, the inputted single beam 1 of the single mode may be dispersed and converted into the multi single beam 2 of the multi single mode to be directed in parallel by the collimating lens.

That is, in the first step ST1, the single beam 1 of the single mode may be transmitted through the material having the first refractive index. In the second step ST2, the converted multi single beam 2 of the multi single mode may be transmitted through the material having the second refractive index higher than the first refractive index.

In the third step ST3, the multi single beam 2 of the multi single mode may be collected via the collimating lens 42 and may be collected through the focusing lens 43 within the housing 41 to be output to the outlet 412. In the third step ST3, a magnification factor M of a magnification (f_{foc}) of the focusing lens 43 to a magnification (f_{coll}) of the collimating lens 42 may be expressed by the equation M=f_{foc}/f_{coll}, and the magnification factor M may be set to 1.2 to 1.8.

In the fourth step ST4, the multi single beam 2 of the multi single mode may be connected to the outlet 412 of the housing 41 through the output fiber 51 to be outputted. In addition, if the propagation fiber 52 is provided, in the fourth step ST4, the multi single beam 2 may be outputted further via the propagation fiber 52.

The inputted single beam 1 of the single mode may be converted to the multi single beam 2 of the multi single mode while passing through the collimating lens 42 and the focusing lens 43 in the housing 41. The multi single beam 2 of the multi single mode may be transmitted through a material having a high refractive index of the propagation fiber 52 and the output fiber 51. At this time, as several multi modes among a large number of multi modes of the multi single beam 2 are reduced, a homogeneous high-density multi single beam 2 with a reduced phase difference may be generated. The multi single beam 2 of the multi single mode may then be output to the output fiber 51.

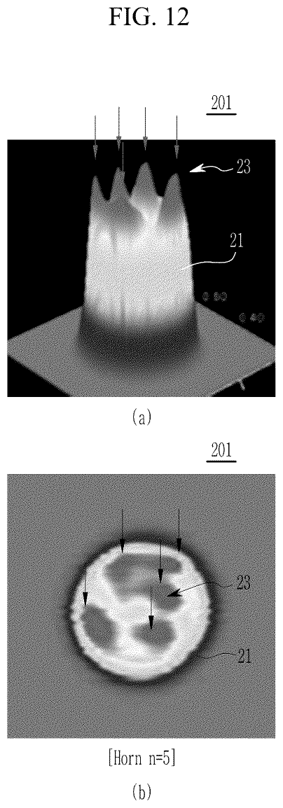

FIGS. 12 to 15 are perspective views (a) and plan views (b) of a multi single beam of a multi single mode converted by the device and method for converting a single beam of a single mode to a multi single beam of a multi single mode according to one or more embodiments of the present disclosure.

Referring to FIGS. 12 to 15, the multi single beam 2 of the multi single mode outputted to the output fiber 51 may have speckle and horn shapes having a plurality of peaks and valleys in a Top-Hat Formfactor.

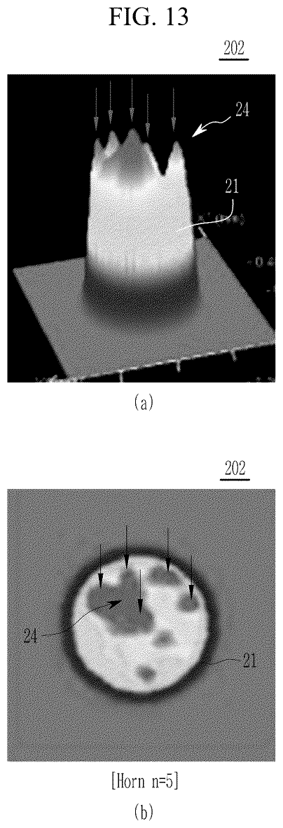

Referring to FIGS. 12 and 13, multi single beams 201 and 202 of a multi single mode may include a single portion 21 that has a reduced multi-mode, a decreased phase difference, and a homogeneous density while transmitting the single beam 1 of the single mode through a material having a first refractive index and transmitting the single beam 1 through a material having a second refractive index higher than the first refractive index, and a plurality of multi portions 23 and 24 formed in the single portion 21.

If viewing the multi single beams 201 and 202 of the multi single mode from the side (a), the multi portions 23 and 24 may form a plurality of peaks and valleys and may have five horns. If viewed from the plane (b), the multi portion 23 may form a speckle shape by the plurality of peaks and valleys and may have 5 horns.

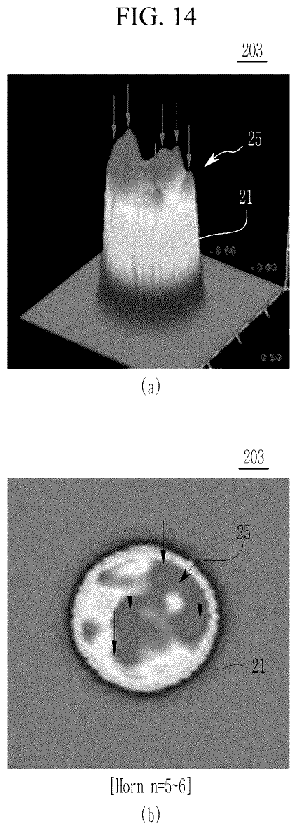

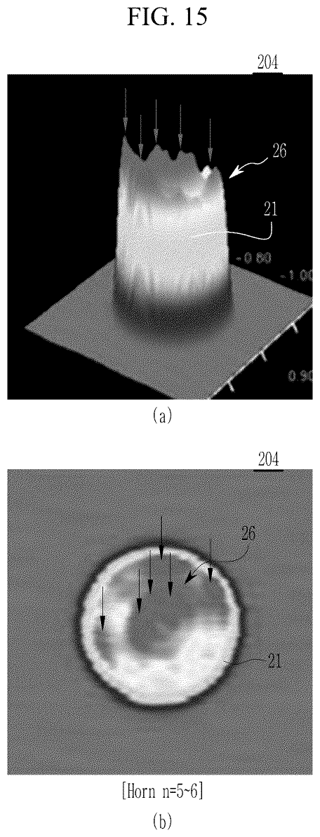

Referring to FIGS. 14 and 15, multi single beams 203 and 204 of a multi single mode may include a single portion 21 that has a reduced multi-mode, a decreased phase difference, and a homogeneous density while transmitting the single beam 1 of the single mode through a material having a first refractive index and transmitting the single beam 1 through a material having a second refractive index higher than the first refractive index, and a plurality of multi portions 25 and 26 formed in the single portion 21.

If viewing the multi single beams 203 and 204 of the multi single mode from the side (a), the multi portions 25 and 26 may form a plurality of peaks and valleys and may have 5 horns. If viewed from the plane (b), the multi portions 25 and 26 may form a speckle shape by the plurality of peaks and valleys and may have 5 to 6 horns.

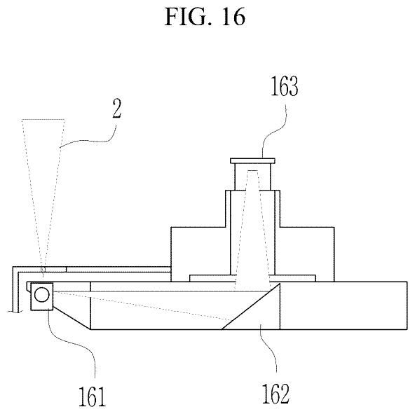

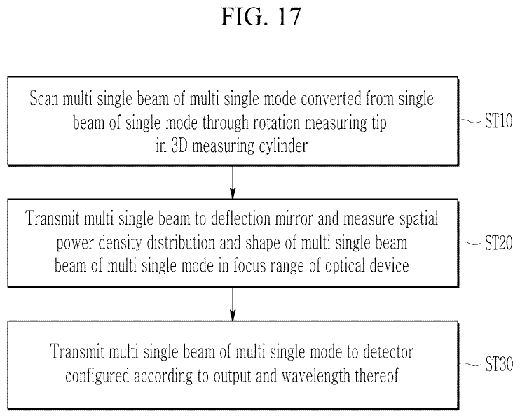

FIG. 16 is a schematic diagram of a device for measuring a multi single beam of a multi single mode converted by the device and method for converting a single beam of a single mode to a multi single beam of a multi single mode according to one or more embodiments of the present disclosure, and FIG. 17 is a flowchart of a method for measuring a multi single beam of a multi single mode using the device of FIG. 16 according to one or more embodiments of the present disclosure.

Referring to FIGS. 16 and 17, a method for measuring a multi single beam of a multi single mode may include a first step ST10, a second step ST20, and a third step ST30. The measuring method may measure the shape of a multi single beam 2 of a multi single mode having speckle and horn shapes having a plurality of peaks and valleys in a Top-Hat Formfactor.

In the first step ST10, the multi single beam 2 of the multi single mode converted from the single beam 1 of the single mode may be scanned through a rotation measuring tip 161 in a 3D measuring cylinder. The rotation measuring tip 161 may have an opening point, and for example, the opening may be 20 μm. In the first step ST10, the multi single beam 2 may be scanned through the rotation measuring tip 161 having the opening point.

In the second step ST20, the multi single beam 2 of the multi single mode may be transmitted to a deflection mirror 162 and then a spatial power density distribution and the shape of the multi single beam 2 of the multi single mode may be measured in a focal range of an optical device. In the third step ST30, the multi single beam 2 of the multi single mode may be transmitted to a detector 163 configured according to an output and a wavelength thereof.

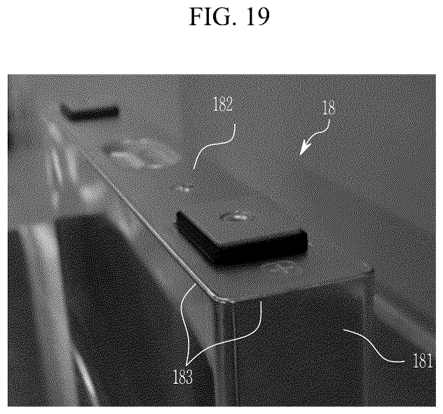

FIG. 18 is a state diagram of a multi single beam welded with the multi single beam of the multi single mode converted by the device and method for converting a single beam of a single mode to a multi single beam of a multi single mode according to one or more embodiments of the present disclosure, and FIG. 19 is a perspective view of a rechargeable battery in which a cap plate and a case are welded with the multi single beam of the multi single mode of FIG. 18 according to one or more embodiments of the present disclosure.

Referring to FIGS. 18 and 19, a rechargeable battery 18 may include a case 181, a cap plate 182, and a welding portion 183, and the welding portion 183 may be welded with the multi single beam 2. The case 181 may include an electrode assembly (not shown), and the cap plate 182 may seal the opening of the case 181 and may be welded.

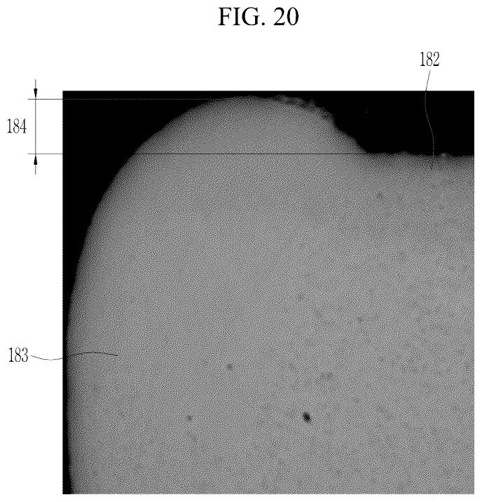

That is, the multi single beam 2 with 5 to 6 peaks may stabilize a melting pool, thereby facilitating the discharge of gas and impurities from a keyhole (KH) during high-speed welding. As a result, the welding portion 183 may further include a reinforcing portion 184 (see FIG. 20) that protrudes from the outer surface of the cap plate 182, the occurrence of pores is reduced, and the quality of weld beads may be improved.

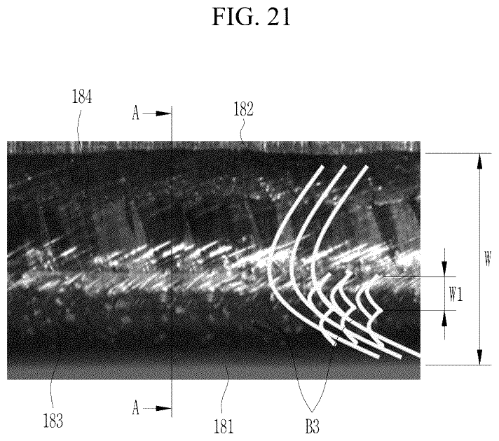

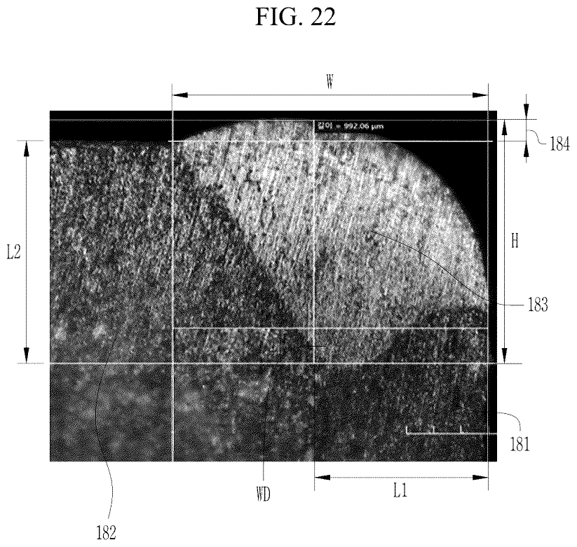

FIG. 20 is a side image of the welding portion in FIG. 19 according to one or more embodiments, FIG. 21 is a planar image of the welding portion in FIG. 19 according to one or more embodiments, and FIG. 22 is a cross-sectional image of the welding portion taken along line A-A of FIG. 21 according to one or more embodiments.

Referring to FIGS. 18 to 23, a first length L1 from a welding depth (WD) of the welding portion 184 to the outer surface of the case 181 and a second length L2 from the welding depth (WD) to the outer surface of the cap plate 182 may be set, and the first length L1 may be smaller than the second length L2 (L1<L2). The length relationship (L1<L2) enables easy formation of the reinforcing portion 184 on the cap plate 182 side.

The welding portion 183 including the reinforcing portion 184 may have a width W set in a direction parallel to the cap plate 182 and a height H set in a direction parallel to the case 181. A ratio (W/H) of the width W to the height H may be 0.5 to 2.0. If the ratio is less than 0.5, the role of the reinforcing portion 184 may be insignificant, and if the ratio is more than 2.0, the welding speed may be further increased, but since the speed is lowered, productivity may not be fully utilized.

The welding portion 183 may include equiaxed tear-shaped beads. The beads may form a plurality of beads B₃ having a width W1 smaller than the width W in a width direction with respect to the entire width W of the welding portion 183. The multi single beam 2 of the multi single mode may form the plurality of beads B₃ with the small width W1.

The reinforcing portion 184 may protrude 5 μm to 200 μm more than the outer surface of the cap plate 182. In the case of 5 μm, the role of the reinforcing portion 184 may be insignificant, and in the case of more than 200 μm, the welding speed may be further increased, but the speed is lowered, so that the productivity may not be fully utilized.

Since the all-solid-state rechargeable battery provided herein does not use the flammable organic solvent, even if a short circuit occurs, the possibility of fires and explosion may be greatly reduced. Therefore, such a solid-state battery may greatly enhance the safety as compared with the lithium-ion battery using the liquid electrolyte.

In order to ensure weldability in all-solid-state rechargeable batteries, prismatic rechargeable batteries, cylindrical rechargeable batteries, modules and packs processes, welding may be performed with high-output energy to secure the strength and sealing technology of thin plate, middle plate, and thick plate parts.

However, due to an unstable melting pool, a discontinuous instruction section of a welding portion may increase, and may spatter metal foreign material, which is a side effect caused during welding, may increase due to unstable fluidity in a molten metal. Therefore, considering productivity, an increase in welding speed is preferred.

In addition, due to a keyhole mechanism of aluminum metal welding, if the welding speed increases, a decrease in surface tension and flow force that moves into a melting pool is intended to be overcome through a stable heat input of laser welding. Therefore, by minimizing the thermal conductivity and latent heat of an aluminum base material that is lost during welding, stable welding quality and control of the spatter metal foreign material may be enabled.

The present disclosure provides a method and device for converting a single beam of a single mode to a multi single beam of a multi single mode. The present disclosure also provides a multi single beam converted by the method for converting a single beam of a single mode to a multi single beam of a multi single mode. The present disclosure also provides a method for measuring a multi single beam by the method for converting a single beam of a single mode to a multi single beam of a multi single mode. The present disclosure further provides a rechargeable battery welded with a multi single beam converted by the method for converting a single beam of a single mode to a multi single beam of a multi single mode.

According to the embodiments, it is possible to ensure weldability even in the case of thin plate, medium plate, and thick plate parts in rechargeable battery, module, and pack processes, which are welded with a multi single beam of a multi single mode converted from a single beam of a single mode.

The multi single beam of one or more embodiments may facilitate the discharge of gases and impurities from a keyhole during high-speed welding due to stabilization of a melting pool, reduce the occurrence of pores, and improve the quality of the weld beads.

The multi single beam of one or more embodiments provides a stable heat input for laser welding of a portion having reduced surface tension and flow force that moves inside the melting pool if the welding speed increases due to a mechanism in a keyhole of aluminum metal welding, thereby minimizing the thermal conductivity and latent heat of an aluminum base material that may be lost during welding.

Therefore, it is possible to control stable welding quality and spattering of metal foreign matter.

The present disclosure includes only some embodiments for performing the dental cleaning set, but is not limited to the embodiments. As claimed in the appended claims, without departing from the gist of the present disclosure, various changes can be implemented by those of ordinary skill in the art.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

<Description of reference numbers>

| | |
|---|---|
| 1: Single beam of single mode | 2: Multi single beam of multi |
| | single mode |
| 18: Rechargeable battery | 21: Single portion |
| 22, 23, 24, 25, 26: Multi portion | 31: Input fiber |
| 41: Housing | 42: Collimating lens |
| 43: Focusing lens | 51: Output fiber |
| 52: Propagation fiber | 161: Rotation measuring tip |
| 162: Deflection mirror | 163: Detector |
| 181: Case | 182: Cap plate |
| 183: Welding portion | 184: Reinforcing portion |
| 201, 202: Multi single beam of | |
| multi single mode | |
| 203, 204: Multi single beam of | |
| multi single mode | |
| 411: Inlet | 412: Outlet |
| 511: Acceptance cone | b1: Guided beam |
| b2: Unguided beam | B3: Bead |
| H: Height | L1: First length |
| L2: Second length | W: Width |
| W1: Small width | WD: Welding depth |
| θ1: First angle | θ2: Second angle |
| θ3: Third angle | |

What is claimed is:

1. A device for converting a single beam of a single mode to a multi single beam of a multi single mode, the device comprising:
an input fiber configured to input the single beam of the single mode;
a collimating lens within a housing connected to the input fiber and configured to convert the single beam of the single mode to the multi single beam of the multi single mode to be directed in parallel while passing the single beam of the single mode inputted to an inlet of the housing;
a focusing lens within the housing and configured to collect the multi single beam of the multi single mode via the collimating lens to be directed to an outlet of the housing; and
an output fiber connected to the outlet of the housing and configured to output the multi single beam of the multi single mode.

2. The device as claimed in claim 1, wherein:
a magnification factor (M) of a magnification (f_{foc}) of the focusing lens to a magnification (f_{coll}) of the collimating lens is expressed by
Equation M=f_{foc}/f_{coll}, and
the magnification factor (M) is 1.2 to 1.8.

3. The device as claimed in claim 1, wherein the collimating lens includes:
a single lens; and
a plurality of focusing lenses are provided sequentially in parallel.

4. The device as claimed in claim 1, further comprising:
a propagation fiber situated between the outlet of the housing and the output fiber,
wherein the propagation fiber selects a guided beam and an unguided beam at a predetermined angle from the multi single beam of the multi single mode.

5. The device as claimed in claim 1, wherein:
the input fiber transmits the single beam of the single mode through a material having a first refractive index, and
the housing transmits the multi single beam of the multi single mode through a material having a second refractive index higher than the first refractive index.

6. The device as claimed in claim 1, wherein:
the multi single beam of the multi single mode includes:
a single portion that has a reduced multi single mode, a decreased phase difference and a homogeneous density while transmitting a single beam of a single mode through a material having a first refractive index and transmitting the single beam through a material having a second refractive index higher than the first refractive index; and
a plurality of multi portions formed in the single portion.

7. The welding tool as claimed in claim 6, wherein if the multi single beam of the multi single mode is viewed from a side, the multi portions form a plurality of peaks and valleys.

8. The welding tool as claimed in claim 7, wherein, if viewed from a plane, the multi portions form a speckle shape by the plurality of peaks and valleys.

9. A method for measuring a multi single beam of a multi single mode, the method comprising:
scanning a multi single beam of a multi single mode converted from a single beam of a single mode through a rotation measuring tip in a 3D measuring cylinder;
transmitting the multi single beam of the multi single mode to a deflection mirror and measuring a spatial power density distribution and a shape of the multi single beam of the multi single mode in a focus range of an optical device; and
transmitting the multi single beam of the multi single mode to a detector configured according to an output and a wavelength thereof.

10. The method as claimed in claim 9, wherein the scanning includes measuring the multi single beam of the multi single mode through a rotation measuring tip having an opening tip.

11. A rechargeable battery welded with a multi single beam of a multi single mode converted from a single beam of a single mode, the rechargeable battery comprising:
a case including an electrode assembly; and
a cap plate welded by sealing an opening of the case, wherein:
the case and the cap plate are welded with a multi single beam of a multi single mode converted from a single beam of a single mode to form a welding portion, and
the welding portion further includes a reinforcing portion protruding more than an outer surface of the cap plate.

12. The rechargeable battery as claimed in claim 11, wherein:
a first length from a welding depth of the welding portion to the outer surface of the case and
a second length from the welding depth to the outer surface of the cap plate are set, and
the first length is smaller than the second length.

13. The rechargeable battery as claimed in claim 12, wherein:
the welding portion including the reinforcing portion has a width (W) set in a direction parallel to the cap plate,
a height (H) set in a direction parallel to the case, and
a ratio (W/H) of the width (W) to the height (H) is 0.5 to 2.0.

14. The rechargeable battery as claimed in claim 11, wherein the welding portion includes equiaxed tear-shaped beads.

15. The rechargeable battery as claimed in claim 14, wherein the equiaxed tear-shaped beads include a plurality of beads having a width smaller than the width in a width direction with respect to the entire width of the welding portion.

16. The rechargeable battery as claimed in claim 11, wherein the reinforcing portion protrudes 5 μm to 200 μm more than the outer surface of the cap plate.
